(19) United States
(12) Patent Application Publication
(10) Pub. No.: US 2020/0398548 A1
(43) Pub. Date: Dec. 24, 2020

(54) SKIN MATERIAL AND METHOD FOR PRODUCING SKIN MATERIAL

(71) Applicant: TS TECH CO., LTD., Saitama (JP)

(72) Inventors: Junichi TAKAHASHI, Tochigi (JP); Takako MIYOSHI, Tochigi (JP)

(21) Appl. No.: 16/954,887

(22) PCT Filed: Dec. 18, 2018
(86) PCT No.: PCT/JP2018/046565

§ 371 Date: Jun. 17, 2020

(30) Foreign Application Priority Data
Dec. 19, 2017 (JP) 2017-243046

(51) Int. Cl. B32B 38/04; B32B 5/28; D04B 21/16; D06C 11/00; D06N 3/00; B60N 2/58

(52) U.S. Cl. CPC B32B 38/04; B32B 5/28; D04B 21/16; B32B 2038/042; D06N 3/0002; B60N 2/58; D06C 11/00

(57) ABSTRACT

To prevent fraying of fibers around a hole when the hole is formed in a skin material. A skin material (1) includes a base fabric layer (5) and a top layer (3) provided at a position opposite to the base fabric layer (5). Holes (3a, 5a) are formed in both the top layer (3) and the base fabric layer (5), and the base fabric layer (5) includes a base fabric layer bottom portion (5b) provided at a position farthest from the top layer (3) in a thickness direction. Fibers constituting the base fabric layer bottom portion (5b) are in a raised state, and each of the fibers is impregnated with resin.

### TECHNICAL FIELD

The present invention relates to a skin material, and more particularly, to a skin material having a plurality of holes formed in a skin and a method for producing the skin material.

### BACKGROUND ART

Among conveyance seats, there is a seat in which a blower device is attached to a seat body to allow air to be sent to an occupant sitting on the seat. In such a conveyance seat, the air generated by the blower device reaches the body of the occupant through the interior of the seat. Thus, in the conveyance seat to which the blower device is attached, ventilation holes are generally drilled in a skin material that is a seat component.

As an example of a skin material in which ventilation hole are formed, a skin described in Patent Literature 1 is given. A skin material described in Patent Literature 1 includes a skin layer (a top layer), an adhesive layer, and a base fabric layer, and the base fabric layer includes fibers having a synthetic resin coating layer.

### CITATION LIST

### Patent Literature

PATENT LITERATURE 1: JP 2016-129994 A

### SUMMARY OF INVENTION

### Technical Problem

When holes are formed in a skin material, some of the fibers of the base fabric layer may be unraveled and come out of the top layer as yarn, so that fraying may occur. In Patent Literature 1, in order to prevent fraying of the yarn, a synthetic resin coating layer is formed around core fibers, and the fibers are partially fused to each other. In this way, the skin material described in Patent Literature 1 requires a little effort for production to fuse the fibers to each other. Therefore, it is desired that a skin material capable of preventing fraying of yarn in a base fabric is realized by a configuration different from that of Patent Literature 1.

Thus, the present invention has been made in view of the problem described above, and an object thereof is to provide a skin material capable of preventing fraying of fibers around a hole when the hole is formed in the skin material.

### Solution to Problem

According to a skin material of the present invention, the problem described above is solved by the skin material including a base fabric layer and a top layer provided at a position opposite to the base fabric layer, wherein holes are formed in both the top layer and the base fabric layer, the base fabric layer includes a base fabric layer bottom portion provided at a position farthest from the top layer in a thickness direction, fibers constituting the base fabric layer bottom portion are in a raised state, and each of the fibers is impregnated with resin.

In the skin material configured as described above, since the raised fibers are formed on the back side of the base fabric layer, the fibers are easily entangled with each other, as well as, the skin material is easily impregnated with resin. Thus, even when through holes are formed in the skin material, it is possible to prevent the fibers from coming out through the through holes to the surface, that is, prevent fraying of the fibers around the holes. Therefore, it is possible to increase an opening ratio of the skin material, and it is possible to improve the degree of freedom in design when the skin material is used as a punching leather.

In the configuration described above, the base fabric layer may be composed of a tricot knit fabric, and the tricot knit fabric may be torn to form the raised fibers.

With the above configuration, since tricot knitting yarn is torn, the fibers are easily entangled with each other, and thus it is possible to further prevent fraying of the fibers around the holes.

In the configuration described above, the base fabric layer may include a plurality of layers, and only a lowermost layer constituting the base fabric layer bottom portion may be torn.

With the above configuration, since only the lowermost layer constituting the base fabric layer bottom portion is torn, it is possible to prevent fraying of the fibers around the holes while preventing the strength of the base fabric layer from being reduced.

In the configuration described above, it is preferable that each of the fibers is impregnated with a polyester resin.

With the above configuration, since the polyester resin is used, the strength of a base fabric is increased compared to that when the resin such as a urethane resin or an acrylic resin is used. Thus, it is possible to further prevent fraying of the yarn when holes are punched.

In this case, it is preferable that the base fabric layer includes a first layer close to the top layer in the thickness direction, and a second layer farther from the top layer than the first layer, and the second layer is composed of yarn thinner than the first layer.

In the skin material configured as described above, it is possible to effectively reduce the amount of yarn used while maintaining the rigidity of the base fabric layer, so that cost reduction and weight reduction are realized. In addition, since the yarn of the second layer is thin, the skin material can be easily bent, so that the assemblability of the skin material to a seat frame and a cushion pad is improved. Furthermore, wear due to contact between the cushion pad and the second layer is prevented.

In this case, it is preferable that the first layer includes a back layer close to the top layer in the thickness direction, and a middle layer farther from the top layer than the first layer, and yarn sewing methods in the back layer and the middle layer are bilaterally symmetrical.

With the above configuration, the rigidity of the base fabric layer can be improved.

In this case, it is preferable that yarn constituting the second layer may have a tensile strength higher than yarn constituting the first layer, and the yarn constituting the second layer may be torn to be raised.

With the above configuration, even when the second layer is torn, it is possible to maintain a well-balanced tensile strength for the first layer. Therefore, the rigidity of the base fabric layer can be efficiently increased.

In this case, it is preferable that the first layer is formed by one needle space, the second layer is formed by two needle spaces, and the second layer is impregnated with resin.

With the above configuration, when a step of tearing the second layer is performed, the first layer may be frayed, but long yarn does not come out. Therefore, the yarn of the first layer is prevented from coming out of the top layer. In addition, when the step of tearing the second layer is performed, long yarn can be come out of the second layer, so that the second layer is easily impregnated with resin.

Further, according to a method for producing a skin material of the present invention, the problem described above is solved by performing a base fabric layer preparation step of preparing a base fabric layer, a raising step of raising fibers constituting a base fabric layer bottom portion of the base fabric layer in a thickness direction, a resin impregnating step of impregnating each of the fibers with resin, a layering step of layering the base fabric layer and the top layer, and a punching step of forming holes in both the top layer and the base fabric layer.

In the method for producing a skin material described above, since the raised fibers are formed on the back side of the base fabric layer, the fibers are easily entangled with each other, as well as, the skin material is easily impregnated with resin. Thus, even when through holes are formed in the skin material, the fibers are prevented from coming out through the through holes to the surface. Therefore, it is possible to increase an opening ratio of the skin material, and it is possible to improve the degree of freedom in design when the skin material is used as a punching leather.

In the configuration described above, it is preferable that the base fabric layer is composed of a tricot knit fabric, and in the raising step, the tricot knit fabric is torn to form the raised fibers.

With the above configuration, since the tricot knitting yarn is torn, the fibers are easily entangled with each other, and thus it is possible to further prevent fraying of the fibers around the holes.

### Advantageous Effects of Invention

According to a skin material of the present invention, even when through holes are formed in the skin material, it is possible to prevent the fibers from coming out through the through holes to the surface, that is, prevent fraying of the fibers around the holes.

Further, according to the skin material of the present invention, since tricot knitting yarn is torn, the fibers are easily entangled with each other, and thus it is possible to further prevent fraying of the fibers around the holes.

Further, according to the skin material of the present invention, since only the lowermost layer constituting the base fabric layer bottom portion is torn, it is possible to prevent fraying of the fibers around the holes while preventing the strength of the base fabric layer from being reduced.

Further, according to the skin material of the present invention, since the polyester resin is used, the strength of a base fabric is increased compared to that when the resin such as a urethane resin or an acrylic resin is used. Thus, it is possible to further prevent fraying of the yarn when holes are punched.

Further, according to the skin material of the present invention, it is possible to effectively reduce the amount of yarn used while maintaining the rigidity of the base fabric layer, so that cost reduction and weight reduction are realized. In addition, since the yarn of the second layer is thin, the skin material can be easily bent, the assemblability of the skin material to a seat frame and a cushion pad is improved. Furthermore, wear due to contact between the cushion pad and the second layer is prevented.

Further, according to the skin material of the present invention, the rigidity of the base fabric layer can be improved.

Further, according to the skin material of the present invention, even when the second layer is torn, it is possible to maintain a well-balanced tensile strength for the first layer. Therefore, the rigidity of the base fabric layer can be efficiently increased.

Further, according to the skin material of the present invention, when a step of tearing the second layer is performed, the first layer may be frayed, but long yarn does not come out. Therefore, the yarn constituting the first layer is prevented from coming out of the top layer. In addition, when the step of tearing the second layer is performed, long yarn can be come out of the second layer, so that the second layer is easily impregnated with resin.

Further, according to a method for producing a skin material of the present invention, even when through holes are formed in the skin material, the fibers are prevented from coming out through the through hole to the surface.

Further, according to the method for producing a skin material of the present invention, since the tricot knitting yarn is torn, the fibers are easily entangled with each other, and thus it is possible to further prevent fraying of the fibers around the holes.

### BRIEF DESCRIPTION OF DRAWINGS

FIG. 1 is an overall view of a conveyance seat according to an embodiment of the present invention.

FIG. 2 is a view showing a seat body and a blower device of the conveyance seat.

FIG. 3 is a schematic enlarged view showing a layered structure of a skin.

FIG. 4 is a schematic enlarged view showing a layered structure of a base fabric layer.

FIG. 5 is a schematic view showing knitting in each layer constituting the base fabric layer.

FIG. 6 is a flowchart showing a method for producing a skin material according to an embodiment of the present invention.

FIG. 7 is a view showing respective specifications of a skin according to an embodiment of the present invention and skins according to comparative examples.

FIG. 8 is a view showing respective specifications of skins according to an embodiment of the present invention and a skin according to a comparative example.

FIG. 9 is a flowchart showing a method for producing a skin material according to a modification of the present invention.

### DESCRIPTION OF EMBODIMENTS

Hereinafter, a skin material, a conveyance seat including the skin material, and a method for producing the skin material according to an embodiment of the present invention (the present embodiment) will be described. In the following, an example in which the skin material is used for the conveyance seat will be described. Further, the configuration of a seat mounted on a vehicle (hereinafter, referred to as a vehicle seat S) as an example of the conveyance seat will be described. The conveyance seat according to the present invention is not limited to the vehicle seat, and can be used as a seat mounted on a conveyance (for example, a motorcycle, or a ship or an aircraft) other than a vehicle.

Further, it should be added that the embodiments described below are merely examples for facilitating the understanding of the present invention and do not limit the present invention. That is, the present invention can be changed and improved without departing from the spirit thereof. In addition, it should be understood that equivalents thereof are included in the present invention.

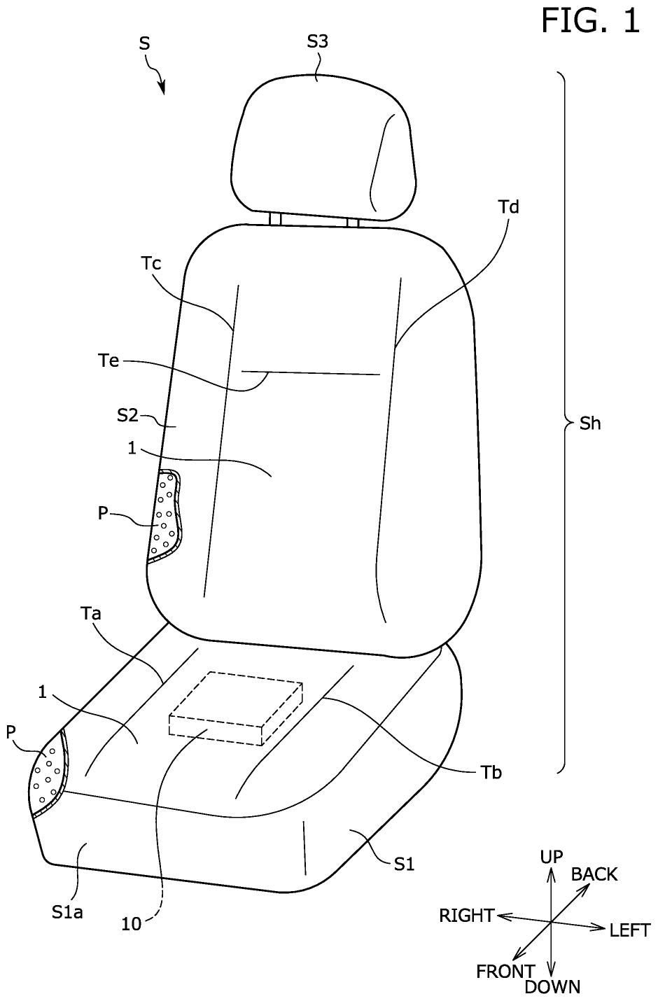

Regarding the term indicating directions in this specification, each direction is defined as shown in FIG. 1. Specifically, in the following description, the term “front to back direction” means a front to back direction when viewed from a seated person of the vehicle seat, and is a direction that coincides with a traveling direction of a vehicle. The term “seat width direction” means a lateral width direction of the vehicle seat, and coincides with a right to left direction when viewed from the seated person of the vehicle seat. Further, the term “up to down direction” means a height direction of the vehicle seat, and coincides with an up to down direction when the vehicle seat is viewed from the front.

<Configuration of Vehicle seat S>

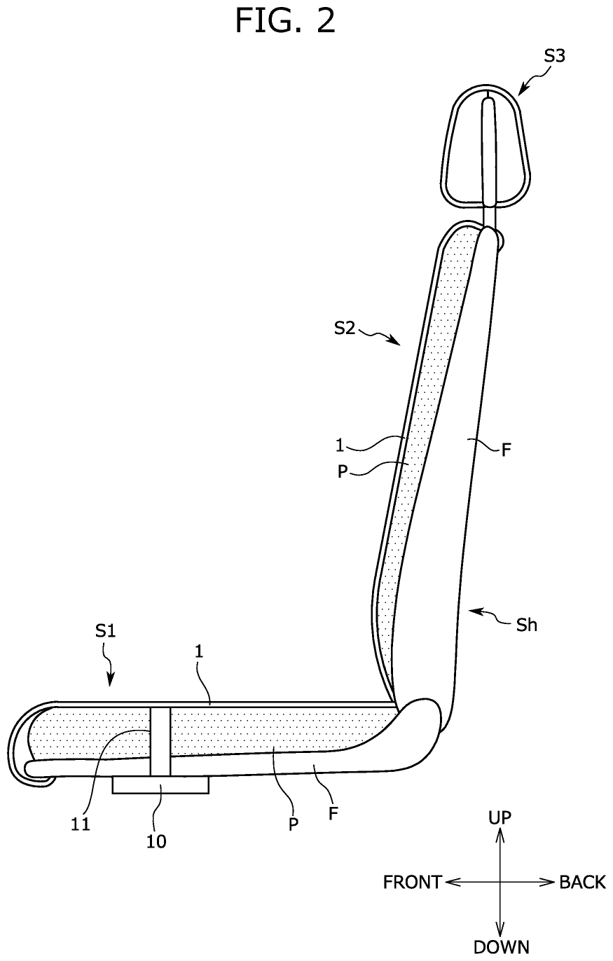

As shown in FIG. 1 and FIG. 2, the vehicle seat S includes a seat body Sh on which an occupant can sit and a blower device 10 attached to the seat body Sh. The seat body Sh includes a seat cushion S1, a seat back S2, and a headrest S3. A cushion pad P is mounted on a frame F and a surface of the cushion pad P is covered with a skin 1 to form the seat cushion S1 and the seat back S2. The skin 1 is a component constituting the seat cushion S1 and the seat back S2, and forms a portion of the seat body Sh, which faces the occupant, specifically, a seating surface.

More specifically, in the seat cushion S1, part of the skin 1 constitutes a surface which supports the buttocks of the occupant seated on the vehicle seat S from below (that is, an upper surface of the seat cushion S1). Further, in the seat back S2, part of the skin 1 constitutes a surface which supports a back of the occupant seated on the vehicle seat S from the back (that is, a front surface of the seat back S2).

In the skin 1 of the seat cushion S1, a pull-in portion Ta (a right side pull-in portion) is provided on the right side of the seat cushion and extends in the front to back direction, and a pull-in portion Tb (a left side pull-in portion) is provided on the left side of the seat cushion and extends in the front to back direction. Further, a front portion of the seat cushion S1 constitutes a front portion S1a with which the back of the knee of the occupant comes into contacts.

In the skin 1 of the seat back S2, a pull-in portion Tc (a right side pull-in portion) is provided on the right side of the seat back S2 and extends in the up to down direction, a pull-in portion Td (a left side pull-in portion) is provided on the left side of the seat back S2 and extends in the up to down direction, and a pull-in portion Te (an upper side pull-in portion) is provided on an upper side of the seat back S2 and extends in the seat width direction.

The blower device 10 is a device provided for air conditioning and ventilation, and includes, for example, a known blower. As shown in FIG. 2, the blower device 10 is arranged at a position below the seat cushion S1.

Further, in the frame F and the cushion pad P, which constitute the seat cushion S1, a through hole is formed at a position located above the blower device 10, and this through hole forms an air passage 11. In addition, in the air passage 11, a duct (not shown) made of a cylindrical sheet metal material may be arranged.

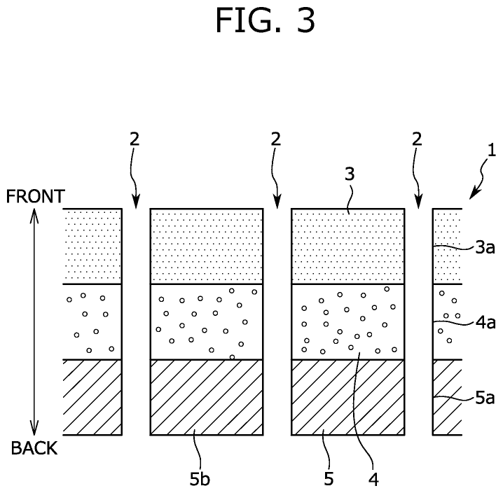

Furthermore, as shown in FIG. 3, in the skin 1 forming the seating surface, a plurality of holes 2 extending through the skin 1 is drilled. The holes 2 are holes through which the air generated by the blower device 10 can pass, and a known perforation process (a drilling process) is performed on the skin 1 to form the holes.

When the blower forming the blower device 10 rotates forward, the air (air flow) from the blower device 10 is sent above the seating surface of the seat cushion S1 through the air passage 11 and the holes 2 to blow against the occupant (strictly speaking, the buttocks of the occupant) sitting on the seat cushion S1. When the blower rotates backward, the atmosphere at or near the seating surface serves as air, and the air is sucked into the blower device 10 through the holes 2 and the air passage 11.

In addition, in the present embodiment, the blower device 10 is attached to the seat cushion S1, but the present invention is not limited to this. The blower device 10 may be attached to the seat back S2 (more specifically, a back portion of the seat back S2).

Further, in the present embodiment, it is preferable that the skin 1, in which a plurality of holes 2 extending therethrough is drilled, is arranged on the inner side of the pair of groove portions which is provided in the seat cushion S1 in the width direction and extends in the front to back direction of the vehicle seat S, that is, on the inner side of the pull-in portion Ta and the pull-in portion Tb, and the skin 1 is thus arranged in a portion with which a leg portion of the occupant comes into contact, allowing the occupant to be effectively prevented from feeling stuffy.

Further, in the present embodiment, it is preferable that the skin 1, in which a plurality of holes 2 extending therethrough is drilled, is arranged in the front portion of the seat cushion S1, that is, the front portion S1a, and the skin 1 is thus arranged in a portion with which the back of the knee of the occupant comes into contact, allowing the occupant to be effectively prevented from feeling stuffy.

In the present embodiment, it is preferable that the skin 1, in which a plurality of holes 2 extending therethrough is drilled, is arranged on the inner side of the pair of groove portions which is provided in the seat back S2 in the width direction and extends in the up to down direction of the vehicle seat S, that is, on the inner side of the pull-in portion Tc and the pull-in portion Td, and the skin 1 is thus arranged in a portion with which the back of the occupant comes into contact, allowing the occupant to be effectively prevented from feeling stuffy.

Further, in the present embodiment, it is preferable that the skin 1, in which a plurality of holes 2 extending therethrough is drilled, is arranged on the lower side of the groove portion which is provided in the seat back S2 and extends in the width direction of the vehicle seat S, that is, on the lower side of the pull-in portion Te, and the skin 1 is thus arranged in a portion with which a waist portion of the occupant comes into contact, allowing the occupant to be effectively prevented from feeling stuffy.

### <Configuration of Skin 1>

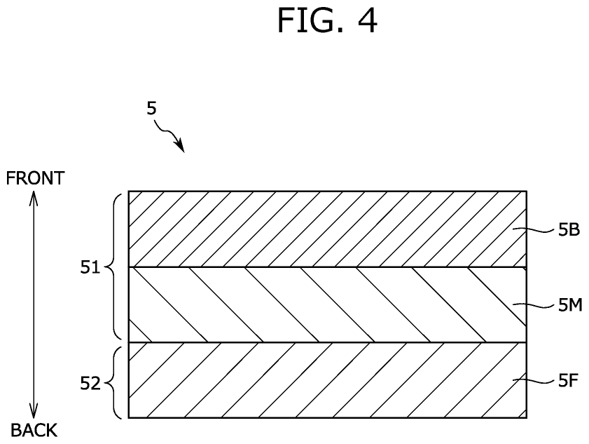

Next, the configuration of skin 1 will be described with reference to FIGS. 3 and 4. As shown in FIG. 3, the skin 1 according to the present embodiment is formed in a layered structure, and specifically is structured in three layers. The layers constituting skin 1 are a top layer 3, a foam layer 4, and a base fabric layer 5.

### (Top Layer 3)

The top layer 3 is a layer provided so as to be located on the front side (the side exposed and facing the occupant) in the thickness direction of the skin 1. Further, in the present embodiment, the top layer 3 is made of polyvinyl chloride (PVC) synthetic leather.

### (Foam Layer 4)

The foam layer 4 is a layer adjacent to the top layer 3 in the thickness direction of the skin 1, and is made of a known wadding material. In addition, an adhesive coating film is formed on a boundary surface between the top layer 3 and the foam layer 4, and the top layer 3 is bonded to a surface of the foam layer 4.

### (Base Fabric Layer 5)

The base fabric layer 5 is a layer provided so as to be located on the back side (the side opposite to the top layer 3) in the thickness direction of the skin 1. The base fabric layer 5 is composed of a fabric formed by knitting fibers, and is more specifically composed of a tricot knit fabric.

The fibers used for the base fabric layer 5 are not particularly limited, and any fiber can be used as long as the fibers can be generally used for a skin material such as synthetic leather. As an example of the fibers, at least one selected from the group consisting of a polyester fiber, a polyamide fiber, a polyurethane fiber, a rayon fiber, a nylon fiber, and a cotton fiber is preferably used, but not limited to these fibers. From the viewpoint of strength and flexibility, a polyester fiber is preferably used. The fibers may consist of one kind of fiber or a blended fiber containing two or more kinds of fibers. Further, fibers, for example, white polyester fibers may be dyed with dye.

The thickness of the fibers used for the base fabric layer 5 is preferably 30 dtex to 150 dtex, more preferably 40 dtex to 120 dtex, further preferably 45 dtex to 90 dtex, and particularly preferably 50 dtex to 75 dtex from the viewpoint of achieving both strength and flexibility.

When the fibers used for the base fabric layer 5 are in a form of a twisted yarn, the fibers are preferably formed in the range of 10 filaments to 100 filaments, more preferably in the range of 20 filaments to 90 filaments, and further preferably in the range of 25 filaments to 80 filaments, and particularly preferably in the range of 30 filaments to 75 filaments.

Further, as described above, in the skin 1, the holes 2 formed by the perforation process are drilled. That is, respective layers (the top layer 3, the foam layer 4, and the base fabric layer 5) constituting the skin 1 are provided with a plurality of respective holes 3a, 4a, and 5a extending through the respective layers. It should be understood that the respective holes of the respective layers are in communication with each other, and are linearly connected to each other as shown in FIG. 3. The air generated by the blower device 10 can pass through the respective holes 3a, 4a, and 5a.

Meanwhile, in general, when a hole is formed in a fabric formed by knitting fibers, the fibers located around the hole are likely to be frayed. On the other hand, in the fabric forming the base fabric layer 5 of the skin 1, it is possible to effectively prevent fraying of the fibers around the holes 5a. Hereinafter, the configuration of the base fabric layer 5 will be described in detail.

In the base fabric layer 5, a portion of the fabric formed by knitting fibers, which corresponds to the base fabric layer bottom portion 5b, is subjected to raising treatment. Therefore, the fibers constituting the base fabric layer bottom portion 5b are in a raised state, and the fibers are easily entangled with each other. Here, the term “base fabric layer bottom portion 5b” is a portion of the base fabric layer 5, which is provided at a position closest to the back side (a position farthest from the top layer 3) in the thickness direction of the skin 1. Here, it is preferable that a tricot knit fabric is torn to form the raised fibers.

The yarn of the base fabric layer bottom portion 5b (a front layer 5F described later) is torn, so that most of the yarn of the base fabric layer bottom portion 5b (the front layer 5F) is short. For this reason, the long yarn does not come out of the through holes, so that the yarn of the base fabric layer bottom portion 5b (the front layer 5F) may come out of the through holes, which is less noticeable.

Here, the raised fibers may be impregnated with resin. As the resin with which the raised fibers are impregnated, a urethane resin, a polyester resin such as a water-based polyester resin, an acrylic resin, or the like can be used, but it is preferable to use a polyester resin from the viewpoint of flexibility, surface characteristics, and strength.

The base fabric layer 5 is composed of a tricot knit fabric formed by knitting a plurality of kinds of fibers as described above. More specifically, as shown in FIG. 4, the base fabric layer 5 is structured in three layers including a back layer 5B, a middle layer 5M, and the front layer 5F, which are layered in order from the front side (the side close to the top layer 3 and the foam layer 4 when these layers are layered) of the base fabric layer 5 in the thickness direction. The front layer 5F constitutes the base fabric layer bottom portion 5b. Here, it is preferable that only the front layer 5F is torn to form the raised fibers. Further, the back layer 5B and the middle layer 5M are collectively referred to as a first layer 51, and the front layer 5F is referred to as a second layer 52.

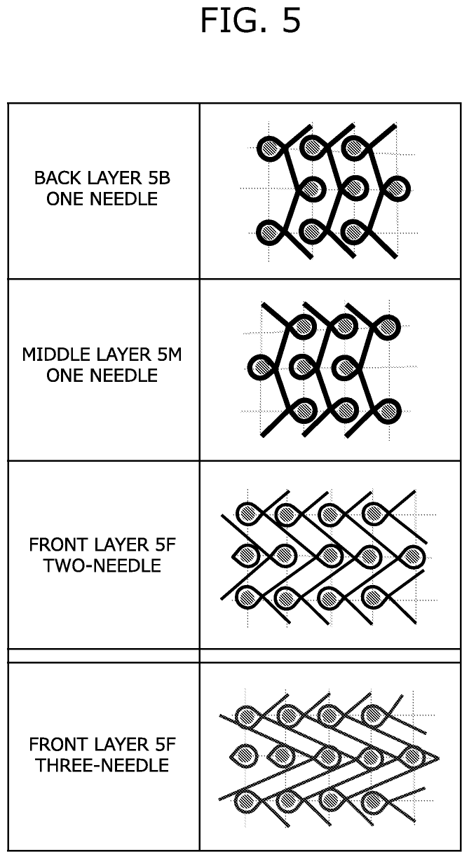

Further, as shown in FIG. 5, it is preferable that the yarn of the back layer 5B and the middle layer 5M (the first layer) are knitted by one needle space and the yarn of the front layer 5F (the second layer) is knitted by two needle spaces. As shown in FIG. 5, yarn sewing methods in the back layer 5B and the middle layer 5M are bilaterally symmetrical. In addition, as shown in FIG. 5, the yarn of the front layer 5F may be knitted by three needle spaces.

In the base fabric layer 5 according to the present embodiment, the thickness of the fibers constituting respective layers may be, for example, 50 d/72 f in the back layer 5B, 75 d/36 f in the middle layer 5M, and 75 d/36 f in the front layer 5F, but not limited to this (d: dtex, f: filament).

### <Method for Producing Skin Material>

A method for producing a skin material according to the present embodiment is characterized by performing a base fabric layer preparation step of preparing a base fabric layer, a raising step of raising fibers constituting a base fabric layer bottom portion of the base fabric layer in a thickness direction, a resin impregnating step of impregnating each of the fibers with resin, a layering step of layering the base fabric layer and the top layer, and a punching step of forming holes in both the top layer and the base fabric layer.

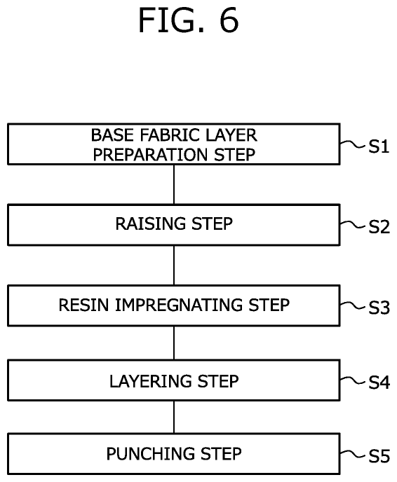

Hereinafter, each step will be described in detail with reference to FIG. 6.

### (Base Fabric Layer Preparation Step)

In the base fabric layer preparation step, the base fabric layer is prepared (step S1). At this time, it is preferable to prepare the base fabric layer including a first layer and a second layer composed of yarn thinner than the first layer and adhere the first layer and the second layer to each other.

### (Raising Step)

In the raising step, the fibers constituting a base fabric layer bottom portion of the base fabric layer in a thickness direction are raised (step S2). Here, the base fabric layer bottom portion corresponds to a portion of the base fabric layer, which is provided at a position farthest from a top layer, in other words, a surface opposite to a surface on which the top layer is layered.

At this time, it is preferable that the base fabric layer is composed of a tricot knit fabric, and in the raising step, the tricot knit fabric is torn to form the raised fibers.

### (Resin Impregnating Step)

In the resin impregnating step, each of the fibers is impregnated with resin (step S3). At this time, it is preferable to use a polyester resin as the resin.

### (Layering Step)

In the layering step, the base fabric layer and the top layer are layered (step S4). Specifically, by a roll coater, an adhesive is applied to a surface of the base fabric layer on the opposite of the base fabric layer bottom portion (a surface of the base fabric layer on the first layer side), and the heated top layer is then bonded thereto by a calendering step. Thus, the base fabric layer and the top layer are adhered to each other, so that the top layer is layered on the first layer side of the base fabric layer. At this time, a layer such as a foam layer may be interposed between the base fabric layer and the top layer.

### (Punching Step)

In the punching step, holes are formed in both the top layer and the base fabric layer (step S5). The formation of the holes may be performed using a known perforation device or a punching roll.

In the skin according to the present embodiment produced in this way, since the raised fibers are formed on the back side of the base fabric layer, the fibers are easily entangled with each other, as well as, the skin is easily impregnated with the resin. Thus, even when through holes are formed in the skin material, the fibers are prevented from coming out through the through holes to the surface.

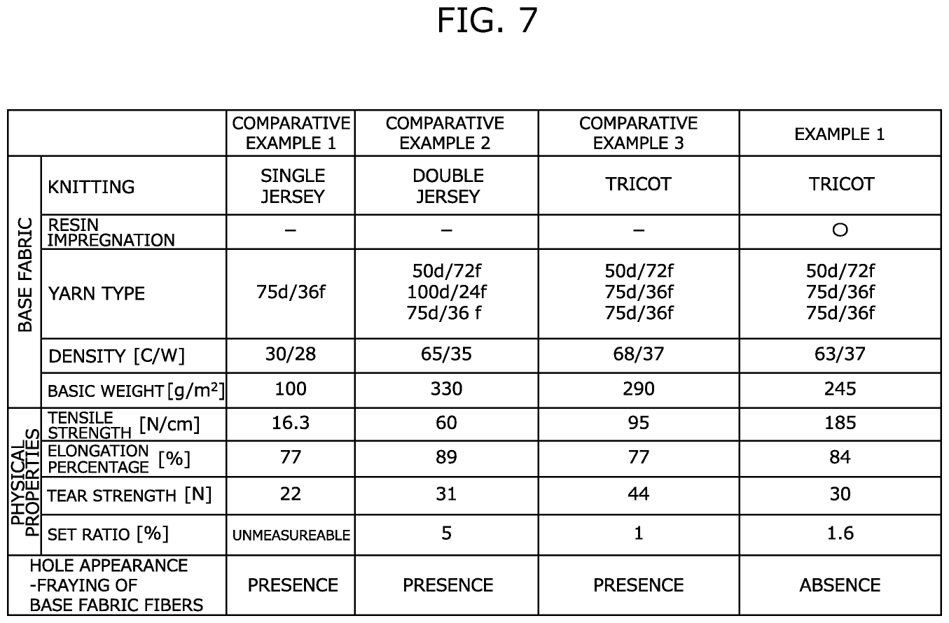

FIG. 7 is a view showing respective specifications of the skin 1 according to the present embodiment (Example 1) and skins according to the comparative examples. In the drawing, the skin 1 according to the present embodiment is represented as “Example 1”. Further, as comparative examples, three examples are given, and in the drawing, respective examples are represented as “Comparative example 1”, “Comparative example 2” and “Comparative example 3”.

In the skin 1 according to the present embodiment (Example 1), the base fabric layer 5 is composed of a fabric formed by knitting three types of yarn by tricot knitting, and the fabric is used as the base fabric layer 5. Further, the specifications of the fabric composing the base fabric layer 5 according to the present embodiment will be described. The basis weight is 245 g/m² or less, and the density is 63 C/37 W.

Furthermore, a portion of the fabric formed by knitting the fibers described above, which corresponds to the base fabric layer bottom portion 5b, is subjected to raising treatment. Therefore, the fibers constituting the base fabric layer bottom portion 5b are in a raised state, and the fibers are easily entangled with each other. Here, the term “base fabric layer bottom portion 5b” is a portion of the base fabric layer 5, which is provided at a position closest to the back side (a position farthest from the top layer 3) in the thickness direction of the skin 1. Here, the base fabric layer 5 is composed of a tricot knit fabric, and the tricot knit fabric is torn to form the raised fibers.

Then, each of the raised fibers constituting the base fabric layer bottom portion is impregnated with a polyester resin. Further, in the present embodiment, the amount of the impregnated polyester resin in each fiber is 1 g to 10 g per unit length of fiber, and is 2 g in Example 1.

As described above, according to the base fabric layer 5 of the skin 1 according to the present embodiment, the entire base fabric layer 5 including portions located at the edges of the holes 5a is composed of a fabric (strictly speaking, a tricot knit fabric) formed by knitting the fibers impregnated with the polyester resin. As a result, the strength around the holes 5a is secured, and fraying of the fibers around the holes 5a is effectively prevented.

In order to explain the effects described above, the description will be made while comparing the base fabric layer 5 of the skin 1 according to the present embodiment and the other base fabric layers (base fabric layers according to comparative examples) different in producing conditions from the base fabric layer 5. As comparative examples, three types of base fabric layers (Comparative example 1, Comparative example 2, and Comparative example 3) will be given, and the specifications (specifically, the knitting of the fibers, the type and thickness of the fibers, the basis weight and density of the fabric, and the presence or absence of impregnation with the polyester resin in the fibers) of the respective base fabric layers are as shown in FIG. 7.

As shown in FIG. 7, the fibers (polyester 100%) of the fabric constituting the base fabric layer 5 of skin 1 according to the present embodiment (hereinafter, the base fabric layer 5 according to this example) are thicker than the fibers of the fabrics constituting the base fabric layers according to Comparative example 1 and Comparative example 2. Further, the basis weight of the fabric constituting the base fabric layer 5 according to Example 1 is larger than the basis weight of the fabric constituting the base fabric layer according to Comparative example 1, as shown in FIG. 7. Further, the density of the fabric constituting the base fabric layer 5 according to Example 1 is higher than the density of the fabrics constituting the base fabric layers according to Comparative example 1 and Comparative example 2, as shown in FIG. 7. Further, as shown in FIG. 7, the fibers of the fabric constituting the base fabric layer 5 according to Example 1 are impregnated with a polyester resin, while no fibers of the fabrics constituting the base fabric layers according to Comparative example 1 to Comparative example 3 are impregnated with a polyester resin. Furthermore, a plurality of holes is drilled in each base fabric layer.

In addition, as shown in FIG. 7, in the base fabric layers according to Comparative examples 1 to 3, fraying of the fibers around the holes occurs, while in the base fabric layer 5 according to Example 1, fraying of the fibers around the holes is prevented. Further, in the base fabric layer 5 according to Example 1, as described above, the fibers constituting the base fabric layer bottom portion 5b are in a raised state and are easily entangled with each other. Combined with such a state, in the base fabric layer 5 according to Example 1, fraying of the fibers around the holes is effectively prevented.

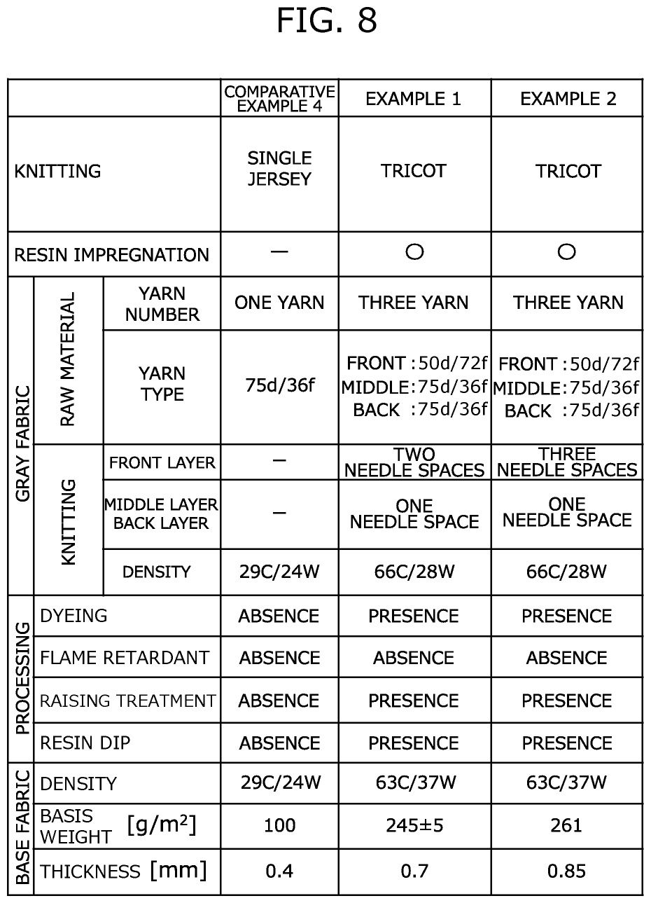

FIG. 8 is a view showing respective specifications of the skins 1 according to the present embodiment (Example 1 and Example 2) and a skin according to a comparative example. In the drawing, the respective skins 1 according to the present embodiment are represented to as “Example 1” and “Example 2”. Further, as a comparative example, one example is given and is represented as “Comparative example 4” in the drawing.

In the skins 1 according to the present embodiment (Example 1 and Example 2), the base fabric layer 5 includes the first layer (the back layer 5B and the middle layer 5M) close to the top layer 3 in the thickness direction, and the second layer (the front layer 5F) farther from the top layer 3 than the first layer, and the second layer (the front layer 5F) is composed of yarn thinner than the first layer (the back layer 5B and the middle layer 5M).

Furthermore, a portion of the fabric formed by knitting the fibers described above, which corresponds to the base fabric layer bottom portion 5b, is subjected to raising treatment. Therefore, the fibers constituting the base fabric layer bottom portion 5b are in a raised state, and the fibers are easily entangled with each other. Here, the term “base fabric layer bottom portion 5b” is a portion of the base fabric layer 5, which is provided at a position closest to the back side (a position farthest from the top layer 3) in the thickness direction of the skin 1. Specifically, the thin yarn constituting the front layer 5F (the second layer) is torn to form the raised fibers. Here, even when the front layer 5F (the second layer) is torn, a well-balanced tensile strength is maintained for the back layer 5B and the middle layer 5M, which are the first layer, increasing the rigidity of the base fabric layer 5.

In the skins 1 according to the present embodiment (Example 1 and Example 2), each of the three types of fibers constituting the base fabric layer 5 is impregnated with a polyester resin. Further, in the present embodiment, the amount of the impregnated polyester resin in each fiber is 1 g to 10 g per unit length of fiber, and is 2 g in Example 2.

Then, the fibers described above are knitted to form a fabric, and the fabric is used as the base fabric layer 5. Further, the specifications of the fabric forming the base fabric layer 5 according to the present embodiment will be described. The basis weight is 261 g/m² or less and the density is 63 C/37 W.

As described above, according to the base fabric layer 5 of the skin 1 according to the present embodiment, it is possible to effectively reduce the amount of yarn used while maintaining the rigidity of the base fabric layer 5, so that cost reduction and weight reduction are realized. In addition, since the yarn of the front layer (the second layer) is thin, the skin material can be easily bent, improving the assemblability of the skin material to the seat frame and the cushion pad. Furthermore, wear due to contact between the cushion pad and the front layer (the second layer) is prevented. Further, the entire base fabric layer 5 including the portions located at the edges of the holes 5a is composed of a fabric (strictly speaking, a tricot knit fabric) formed by knitting the fibers impregnated with a polyester resin. As a result, the strength around the holes 5a is secured, effectively preventing fraying of the fibers around the holes 5a.

In order to explain the effect described above, the description will be made while comparing the base fabric layers 5 of the skins 1 according to the present embodiment (Example 1 and Example 2) and another base fabric layer (the base fabric layer according to a comparative example) different in producing conditions from the base fabric layers 5. Further, as a comparative example, a base fabric layer according to Comparative example 4 will be given, and the specifications of the respective base fabric layers (specifically, the knitting of the fibers, the type and thickness of the fibers, the basis weight and density of the fabric, and the presence or absence of impregnation with the polyester resin in the fibers) are as shown in FIG. 8.

As shown in FIG. 8, the fibers (polyester 100%) of the fabrics constituting the base fabric layers 5 of the skins 1 according to the present embodiment (hereinafter, the base fabric layers 5 according to this example) are 75 d/36 f in the back layer 5B, 75 d/36 f in the middle layer 5M, and 50 d/72 f in the front layer 5F. That is, the front layer 5F (the second layer) is composed of yarn thinner than the back layer 5B and the middle layer 5M (the first layer). Therefore, in the skin 1, the amount of yarn used is reduced while the rigidity of the base fabric layer 5 is maintained.

Here, the back layer 5B and the middle layer 5M (the first layer) are formed by one needle space, and the front layer 5F (the second layer) is formed by three needle spaces (Example 1) or two needle spaces (Example 2). When the step of tearing the front layer 5F (the second layer) is performed, the back layer 5B and the middle layer 5M (the first layer) may be frayed, but long yarn does not come out. Therefore, the yarn of the back layer 5B and the middle layer 5M (the first layer) are prevented from coming out of the top layer. Further, when the step of tearing the front layer 5F (the second layer) is performed, long yarn from the front layer 5F (the second layer) can come out, so that it is easily impregnated with resin.

Further, yarn sewing methods in the back layer 5B and the middle layer 5M are bilaterally symmetrical, improving the rigidity of the base fabric layer 5 (FIG. 5).

The diameter (50 d) of the yarn constituting the front layer 5F (the second layer) is two-thirds of the diameter (75 d) of the yarn constituting the back layer 5B and the middle layer 5M (the first layer). The yarn constituting the front layer 5F has twice the tensile strength as the yarn constituting the middle layer 5M.

Further, as shown in FIG. 8, the basis weight of the fabrics constituting the base fabric layers 5 according to Example 1 and Example 2 is larger than the basis weight of the fabric constituting the base fabric layer according to Comparative example 1. Further, the density of the fabrics constituting the base fabric layers 5 according to Example 1 and Example 2 is higher than the density of the fabric constituting the base fabric layer according to Comparative example 4, as shown in FIG. 8. Further, as shown in FIG. 8, while the fibers of the fabrics constituting the base fabric layers 5 according to Example 1 and Example 2 are impregnated with a polyester resin, the fibers of the fabric constituting the base fabric layer according to Comparative example 4 are not impregnated with a polyester resin. Furthermore, a plurality of holes is drilled in each base fabric layer.

Then, in the base fabric layer according to Comparative example 4, fraying of the fibers around the holes occurred, while in base fabric layers 5 according to Example 1 and Example 2, fraying of the fibers around the holes was prevented. Further, in the base fabric layers 5 according to Example 1 and Example 2, as described above, the fibers constituting the base fabric layer bottom portions 5b are in a raised state and are easily entangled with each other. Combined with such a state, in the base fabric layers 5 according to Example 1 and Example 2, fraying of fibers around the holes was effectively prevented.

### <Modification>

As the use of the skin material, the vehicle seat S provided with the blower device 10 is shown, but the vehicle seat may be provided with a heater instead of the blower device. Further, the vehicle seat may be provided with a heater in addition to the blower device.

Further, in the embodiments described above, an example in which the skin material is used as the skin of the vehicle seat is shown, but the use of the skin material 1 is not limited to this, and the use thereof includes, for example, general interior and clothing, and daily necessities such as shoes, bags, purses, gloves, and belts, which are made of artificial leather, and is not particularly limited.

Further, in the embodiments described above, an example in which synthetic leather made of polyvinyl chloride (PVC) is used as the top layer 3, but the material of the top layer 3 is not limited to this, and for example, the synthetic leather made of urethane may be used.

Further, in the embodiments described above, the skin including the foam layer 4 (in other words, the skin material including the foamed PVC) is shown in FIG. 3. However, the foam layer 4 is not an essential component, and the skin 1 may not be provided with the foam layer 4.

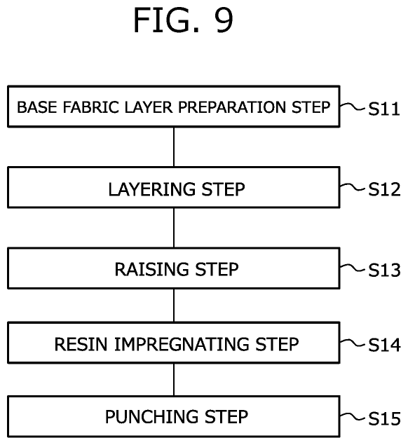

Further, in the method for producing the skin material shown in the embodiments described above, the order of the steps may be changed. For example, as shown in FIG. 9, a method for producing a skin material according to a modification may perform a base fabric layer preparation step (step S11) of preparing a base fabric layer, a layering step (step S12) of layering the base fabric layer and a top layer, a raising step (step S13) of raising fibers constituting a base fabric layer bottom portion of the base fabric layer, which is provided at a position farthest from the top layer in a thickness direction, a resin impregnating step (step S14) of impregnating each of the fibers with resin, and a punching step (step S15) of forming holes in both the top layer and the base fabric layer.

### Reference Example

(Item 1)

A skin material, characterized by including

a base fabric layer, and

a top layer provided at a position opposite to the base fabric layer, wherein

holes are formed in both the top layer and the base fabric layer,

the base fabric layer includes a first layer (a back layer and a middle layer) close to the top layer in a thickness direction, and a second layer (a front layer) farther from the top layer than the first layer, and

the second layer is composed of yarn thinner than the first layer.

According to the skin material of the item 1, it is possible to effectively reduce the amount of yarn used while maintaining the rigidity of the base fabric layer, so that cost reduction and weight reduction are realized. In addition, since the yarn of the second layer is thin, it is easy to bend the skin material, improving the assemblability of the skin material to the seat frame and the cushion pad. Furthermore, wear due to contact between the cushion pad and the second layer is prevented.

(Item 2)

The skin material according to item 1, characterized in that

the first layer includes a back layer close to the top layer in the thickness direction, and a middle layer farther from the top layer than the first layer, and

yarn sewing methods in the back layer and the middle layer are bilaterally symmetrical.

According to the skin material of the item 2, the rigidity of the base fabric layer can be improved.

(Item 3)

The skin material according to item 1 or 2, characterized in that yarn constituting the second layer has a diameter two thirds or less of yarn constituting the first layer.

According to the skin material of item 3, it is possible to more effectively reduce the amount of yarn used while maintaining the rigidity of the base fabric layer.

(Item 4)

The skin material according to item 2, characterized in that yarn constituting the front layer has a tensile strength twice or more yarn constituting the middle layer.

According to the skin material of item 4, it is possible to more effectively reduce the amount of yarn used while maintaining the rigidity of the base fabric layer.

(Item 5)

A conveyance seat including the skin material as described in any one of items 1 to 4, a seat back, and a seat cushion, characterized in that the skin material is arranged on an inner side of a pair of groove portions which is provided in the seat back in a width direction and extends in an up to down direction of the conveyance seat.

According to the skin material of item 5, since the skin material having through holes is arranged in a portion of the convenience seat, with which a back of an occupant comes into contact, it is possible to effectively prevent the occupant feeling stuffy.

(Item 6)

A conveyance seat including the skin material as described in any one of items 1 to 4, a seat back and a seat cushion, characterized in that the skin material is arranged on a lower side of a groove portion which is provided in the seat back and extends in a width direction of the conveyance seat.

According to the skin material of item 6, since the skin material having through holes is arranged in a portion of the conveyance seat, with which a waist portion of an occupant comes into contact, it is possible to effectively prevent the occupant from feeling stuffy.

(Item 7)

A conveyance seat including the skin material as described in any one of items 1 to 4, a seat back, and a seat cushion, characterized in that the skin material is arranged on an inner side of a pair of groove portions which is provided in the seat cushion in a width direction and extends in a front to back direction of the conveyance seat.

According to the skin material of item 7, since the skin material having through holes is arranged in a portion of the convenience seat, with which a leg portion of an occupant comes into contact, it is possible to effectively prevent the occupant from feeling stuffy.

(Item 8)

A conveyance seat including the skin material according to any one of items 1 to 4, a seat back, and a seat cushion, characterized in that the skin material is arranged in a front portion of the seat cushion.

According to the skin material of item 8, since the skin material having through holes is arranged in a portion of the convenience seat, with which the back of a knee of an occupant comes into contact, it is possible to effectively prevent the occupant from feeling stuffy.

(Item 9)

A method for producing a skin material, characterized by including

a base fabric layer preparation step of preparing a base fabric layer including a first layer and a second layer composed of yarn thinner than the first layer,

a layering step of layering a top layer on a side of the first layer of the base fabric layer,

a punching step of forming holes in both the top layer and the base fabric layer.

According to the method for producing a skin material of item 9, it is possible to effectively reduce the amount of the yarn used while maintaining the rigidity of the base fabric layer in the skin material, so that cost reduction and weight reduction are realized.

(Item 10)

The method for producing a skin material according to item 7, characterized in that, in the base fabric layer preparation step, the first layer and the second layer are adhered to each other.

According to the method for producing a skin material of item 10, since the first layer and the second layer of the base fabric layer are adhered to each other, the rigidity of the base fabric layer is improved.

### REFERENCE SIGNS LIST

1: skin (skin material)
2: hole
3: top layer
   3a: hole
4: foam layer
   4a: hole
5: base fabric layer
   5a: hole
   5b: base fabric layer bottom portion
51: first layer
   5B: back layer
   5M: middle layer
52: second layer
   5F: front layer
10: blower device
11: air passage
F: frame
P: cushion pad
S: vehicle seat (conveyance seat)
   S1: seat cushion
      Ta: pull-in portion (right side pull-in portion, groove portion)
      Tb: pull-in portion (left side pull-in portion, groove portion)
      S1a: front portion S2: seat back
      Tc: pull-in portion (right side pull-in portion, groove portion)
      Td: pull-in portion (left side pull-in portion, groove portion)
      Te: pull-in portion (upper side pull-in portion, groove portion)
   S3: headrest
   Sh: seat body

1. A skin material comprising:
a base fabric layer; and
a top layer provided at a position opposite to the base fabric layer, wherein
holes are formed in both the top layer and the base fabric layer,
the base fabric layer includes a base fabric layer bottom portion provided at a position farthest from the top layer in a thickness direction,
fibers constituting the base fabric layer bottom portion are in a raised state, and
each of the fibers is impregnated with resin.

2. The skin material according to claim 1, wherein
the base fabric layer is composed of a tricot knit fabric, and
the tricot knit fabric is torn to form the raised fibers.

3. The skin material according to claim 1, wherein
the base fabric layer includes a plurality of layers, and
only a lowermost layer constituting the base fabric layer bottom portion is torn.

4. The skin material according to claim 1, wherein
each of the fibers is impregnated with a polyester resin.

5. The skin material according to claim 1, wherein
the base fabric layer includes a first layer close to the top layer in the thickness direction, and a second layer farther from the top layer than the first layer, and
the second layer is composed of yarn thinner than the first layer.

6. The skin material according to claim 5, wherein
the first layer includes a back layer close to the top layer in the thickness direction, and a middle layer farther from the top layer than the back layer, and
yarn sewing methods in the back layer and the middle layer are bilaterally symmetrical.

7. The skin material according to claim 5, wherein
yarn constituting the second layer has a tensile strength higher than yarn constituting the first layer, and
the yarn constituting the second layer is torn to be raised.

8. The skin material according to claim 5, wherein
the first layer is formed by one needle space,
the second layer is formed by two needle spaces, and
the second layer is impregnated with resin.

9. A method for producing a skin material, comprising:
a base fabric layer preparation step of preparing a base fabric layer;
a raising step of raising fibers constituting a base fabric layer bottom portion of the base fabric layer in a thickness direction;
a resin impregnating step of impregnating each of the fibers with resin;
a layering step of layering the base fabric layer and the top layer; and
a punching step of forming holes in both the top layer and the base fabric layer.

10. The method for producing a skin material according to claim 9, wherein
the base fabric layer is composed of a tricot knit fabric, and
in the raising step, the tricot knit fabric is torn to form the raised fibers.
